(19) United States
(12) Patent Application Publication
(10) Pub. No.: US 2026/0016170 A1
(43) Pub. Date: Jan. 15, 2026

(54) SOLAR FOOD COOKING DEVICE AND METHODS OF MAKING AND USING THE SAME

(71) Applicant: Rhonda C. Warren, Florence, SC (US)

(72) Inventor: Rhonda C. Warren, Florence, SC (US)

(21) Appl. No.: 19/050,236

(22) Filed: Feb. 11, 2025

Related U.S. Application Data
(60) Provisional application No. 63/670,622, filed on Jul. 12, 2024.

(51) Int. Cl. F24C 7/08; H02J 7/35; H02S 10/20; H02S 20/30; H05B 1/02

(52) U.S. Cl. CPC F24C 7/087; H02S 10/20; H02S 20/30; H05B 1/0263; H02J 7/35

(57) ABSTRACT

A solar food cooking device is provided. The methods of cooking a food product in a solar food cooking device are also provided. Further, the methods of using a solar food cooking device are provided.

### CROSS-REFERENCE TO RELATED APPLICATIONS

This application claims priority to and benefit of U.S. Provisional Patent Application No. 63/670,622 filed on Jul. 12, 2024, which is incorporated by reference in its entirety.

### FIELD OF THE INVENTION

The present invention relates to a solar food cooking device. The present invention, more particularly, relates to a solar food cooking device and methods of making and using the same.

### BACKGROUND OF THE INVENTION

Traditional cooking method such as stove tops, ovens, steaming etc. take long time to cook. One method of quickly cooking food uses microwave ovens. Microwave ovens are widely used for cooking foods in a relatively short amount of time. Although microwave ovens provide an effective system for directly heating foods and liquids, they are not effective with searing and/or grilling foods such as meat, bread or fried food. Additionally, some foods do not cook evenly or well in a microwave. For example, fully cooking meats such as chicken or beef in a microwave often changes the texture and mouth feel of the meat, resulting in “rubbery” or “leathery” meat.

Radiative heat is another way to cook food relatively quickly. However, radiation ovens can heat some lipids effectively, but are less effective at heating water quickly. Additionally, radiation ovens using traditional bulb technology do not heat some lipids/fats effectively and the high heat causes lipids to splatter. As a result, the heated lipids land on the heating element, and actually break the bulbs. Further, microwave oven or radiative oven consume lot of energy.

The prior art does not, however, exemplify high speed cooking device that produces an evenly cooked, yet seared food with a satisfying taste, texture and mouth feels. A need has been recognized in the food industry for a food cooking device that can quickly and thoroughly cook a food product.

Accordingly, a need exists for a food cooking device which can be a solar food cooking device with improved safety, and is cost-effective.

In light of the above, it would be desirable to develop a solar food cooking device which is safe and can cook multiple food products.

Therefore, it is a main object of the present invention to provide a solar food cooking device with improved safety, and is inexpensive.

It is an object of the present invention to provide a solar food cooking device that can be used where there is power outage.

It is also an object of the present invention to provide a solar food cooking device that can be used where there is fuel shortage.

It is another object of the present invention to provide a solar food cooking device that can be used in emergency.

It is still another object of the present invention to provide a solar food cooking device which has a dual power capacity.

It is also an object of the present invention to provide a solar food cooking device that is efficient, environmentally friendly, and a green device.

It is a further object of the present invention to provide a solar food cooking device that can cook multiple food products simultaneously.

These needs and other needs are met by the various aspects of the present disclosure.

### SUMMARY OF THE INVENTION

In accordance with the purpose(s) of this invention, as embodied and broadly described herein, this invention, in one aspect, relates to a solar food cooking device and methods of making and using the same.

In some embodiments of the present invention, a solar food cooking device can include an outer unit; an inner unit; a solar battery; a solar panel; a heating element; an AC power input; a power switch; a solar panel cable; a temperature control knob; a plurality of prongs; a plurality of electric nodes; a solar panel output port; a solar panel input port; an AC/DC switch; and a lid; wherein the outer unit is at the top of the solar battery and holds the inner unit, wherein the inner unit is inside the outer unit and holds the food, wherein the solar battery is at the bottom of the device and holds the outer unit, wherein the solar panel is inside the outer unit and on the back side of device, wherein the solar panel absorbs solar energy from sun and is attached to the solar battery via the solar panel cable, wherein the solar battery stores solar energy from sun, wherein the lid is first placed on the top of the outer unit and the solar food cooking device is then turned on; and wherein when the solar food cooking device is turned on, the solar energy from the solar battery heats the heating clement to cook a food product.

In other embodiments of the present invention, a method of cooking a food product in a solar food cooking device, can include exposing a solar panel to a sun; absorbing a solar energy from sun into the solar panel; transferring the solar energy from the solar panel to a solar battery via a solar panel cable; storing the solar energy into the solar battery; placing a food product to be cooked on a tray or on an inner unit; closing a lid on the top of an outer unit; turning on the solar food cooking device; transferring solar energy from solar battery to heat the food product; and heating the food product with solar energy at a temperature range of about 100° C. to about 175° C. to produce the cooked food product; wherein a time and the temperature of heating varies based on the type of the food product.

In further embodiments of the present invention, a method of using a solar food cooking device, can include charging a solar food cooking device with a solar energy from sun; placing a food product to be cooked on a tray or on an inner unit; closing a lid on the top of an outer unit; turning on the solar food cooking device; heating the food product with solar energy at a temperature range of about 100° C. to about 175° C. to produce a cooked food product; and removing the cooked food product from the solar food cooking device, wherein the solar energy from sun is absorbed by the solar panel, wherein the solar energy is transferred from the solar panel to a solar battery via a solar panel cable to store the solar energy, and wherein the stored solar energy from solar battery is transferred to heat the food product.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 shows the front view of the solar food cooking device.

FIG. 2 shows the back view of the solar food cooking device.

FIG. 3 shows the interior view of the solar food cooking device.

### DETAILED DESCRIPTION OF THE INVENTION

### I. Definitions

The following terms are intended to have the meanings presented therewith below and are useful in understanding the description and intended scope of the present invention.

The articles “a” and “an” may be used herein to refer to one or to more than one (i.e., at least one) of the grammatical objects of the article. By way of example “an analogue” means one analogue or more than one analogue.

The term “about” as used herein, refers that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments. Additionally, in phrase “about X to Y,” is the same as “about X to about Y,” that is the term “about” modifies both “X” and “Y.”

The term “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are used in their inclusive, open-ended, and non-limiting sense.

The term “effective,” as that term is used in the specification and/or claims, means adequate to accomplish a desired, expected, or intended result.

The term “food product” as used herein, refers to a consumable product exposed to heat from a first and/or second heat source. The food product can be a pre-packaged product, or subjected to manufacturing processing before exposure to heat. The food product can be an un-packaged product. In some embodiments, the food product is a consumable product that includes whole fruits or vegetables. In some embodiments, the food product includes asparagus, broccoli, cauliflower, squash, zucchini, potatoes, sweet potatoes, eggplant, carrots, tomatoes, onions, or combinations thereof. In some embodiments, the food product is derived from animal protein, and includes steaks, chops, roasts or ground meat. In some embodiments, the animal protein can include beef, pork, lamb, goat, venison, buffalo, bison, chicken, turkey, pheasant, fish, shellfish, or combinations thereof. In some embodiments, the food product can be a combination of a fruit or vegetable and an animal protein. In some embodiments, the food product can be a battered food product, such as a breaded chicken cutlet, or tempura vegetables.

The term “grilled,” “seared,” or “charred” as used herein, refers to a caramelized crust formed on the surface of a food product as the result of exposure to high heat. In some embodiments, the crust is formed when the surface of the food exceeds 150° C. (300° F.). In some embodiments, the seared crust results in a coloration change of all or a portion of the food product. In some embodiments, the seared crust results in a changed or enhanced flavor of the food product when compared to a food product not exposed to high heat. In some embodiments, a browning, color change or flavor change can be the result of the Maillard Reaction.

### II. Solar Food Cooking Device

The present invention is directed to a solar food cooking device and more particularly, a solar food cooking device and methods of making and using the same. The present invention may be understood more readily by reference to the following detailed description of preferred embodiments of the invention and the Examples included therein and to the Figures and their previous and following description.

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete and will fully convey the scope of the invention to those skilled in the art. In the drawings, like numbers refer to like elements throughout.

The solar food cooking device shown in the figures has parts that are examples of the elements recited in the claims. The solar food cooking device thus includes examples of how a person of ordinary skilled in the art can make and use the claimed invention. It is described here to meet the requirements of enablement and best mode without imposing limitations that are not specified in the claims.

In some embodiments of the present invention, a solar food cooking device can include an outer unit 2; an inner unit 4; a solar battery 6; a solar panel 8; a heating element 10; an AC power input 12; a power switch 14; a solar panel cable 16; a temperature control knob 24; a plurality of prongs 26; a plurality of electric nodes 28; a solar panel output port 34; a solar panel input port 36; an AC/DC switch 42; and a lid 18; wherein the outer unit is at the top of the solar battery and holds the inner unit, wherein the inner unit is inside the outer unit and holds the food, wherein the solar battery is at the bottom of the device and holds the outer unit, wherein the solar panel is inside the outer unit and on the back side of device, wherein the solar panel absorbs solar energy from sun and is attached to the solar battery via the solar panel cable, wherein the solar battery stores solar energy from sun, wherein the lid is first placed on the top of the outer unit and the solar food cooking device is then turned on; and wherein when the solar food cooking device is turned on, the solar energy from the solar battery heats the heating element to cook a food product.

In one embodiment, the solar food cooking device further can include a tray 20.

In some embodiments, the tray is placed inside the inner unit.

In other embodiments, the tray is made up of a material selected from the group consisting of stainless steel, silicon, non-stick material and combinations thereof.

In certain embodiments, the tray holds the food product to be cooked.

In another embodiment, the solar food cooking device further can include a USB port 22 on the solar battery 6.

In some embodiments, the USB port is used to charge an electronic device.

In some embodiments, the temperature control knob 24 indicates a temperature range.

In other embodiments, the outer unit 2 is made up of a material selected from the group consisting of stainless steel, ceramic, plastic, glass, metal, silicon, coils, wires and combinations thereof.

In certain embodiments, the outer unit 2 has the inner unit 4 and the tray 20.

In further embodiments, the outer unit 2 has the heating element 10 housed within the walls of the outer unit 2.

In some embodiments, the heating element 10 has four or more prongs 26.

In other embodiments, the prongs 26 are connected to the solar battery 6.

In certain embodiments, the solar battery 6 transfers the solar energy to the prongs 26 to heat the heating element for cooking the food product.

In further embodiments, the outer unit 2 has handles on both the sides 48 (side handle).

In one embodiment, the outer unit 2 has the power switch 14.

In another embodiment, the power switch 14 is an on/off power switch.

In some embodiments, the inner unit 4 is made up of a material selected from the group consisting of stainless steel, ceramic, metal, silicon, non-stick material and combinations thereof.

In other embodiments, wherein the inner unit 4 holds the food product to be cooked.

In certain embodiments, the inner unit 4 has an optional tray to hold the food product to be cooked.

In further embodiments, the inner unit 4 is removed from the device for easy cleaning.

In some embodiments, the solar battery 6 is at the bottom of the device and holds the outer unit 2.

In other embodiments, the electric nodes 28 hold the prongs 26.

In some embodiments, the solar battery 6 is selected from the group consisting of a lead acid battery, a lithium-ion battery, a nickel-based battery, a flow battery a LiFePO4 battery and combinations thereof.

In another embodiment, the nickel-based battery is a nickel cadmium battery.

In some embodiments, the AC power input 12 has an AC power cable 30 to charge solar battery.

In another embodiment, the solar food cooking device further can include an AC power cable 30 for AC outlet charging.

In some embodiments, the AC power cable 30 transfers AC to solar battery when connected to alternate power source.

In one embodiment, the AC power cable 30 is detachable.

In another embodiment, the solar food cooking device further can include a battery life indicator window 32 showing the percentage of charge in the solar battery 6.

In some embodiments, the solar panel 8 is removed from the back side of the outer unit once a battery is reached a full charge mode or can remain inside the outer unit while device is in cook mode.

In other embodiments, the solar panel 8 is connected to the solar battery 6 via the solar panel cable 16.

In certain embodiments, the solar panel cable 16 transfers solar energy from solar panel 8 to solar battery 6.

In one embodiment, the lid 18 is a detachable lid.

In another embodiment, the lid 18 is round in shape.

In certain embodiments, the lid 18 has a handle on the top 46 (lid handle).

In further embodiments, the lid 18 is made up of a material selected from the group consisting of glass, silicon, stainless steel, wood and combinations thereof.

In some embodiments, the solar panel output port 34 connects solar panel cable 16 to allow solar energy to flow out of solar panel 8.

In other embodiments, the solar panel input port 36 connects solar panel cable 16 to allow solar energy to flow into solar battery 6.

In certain embodiments, the AC/DC switch 42 allows solar food cooking device to cook the food product with either alternating current or direct current.

In some embodiments, the solar food cooking device further can include a DC input 38 for connecting car charging cable 40 to the solar battery to allow direct current to flow into solar battery 6.

In other embodiments, the solar food cooking device further can include a car charging cable 40 for connecting the solar battery via DC input 38 to allow direct current to flow into solar battery 6.

In certain embodiments, the solar food cooking device further can include an inverter 44 for allowing solar battery to use direct current, solar energy, alternate current or combinations thereof.

In one embodiment, the device is a solar food cooker.

In certain embodiments, the food product is selected from the group consisting rice, meat product, beans, vegetable, grain, seafood, fruit, and combinations thereof.

In another embodiment, the device can be used at a destination.

In other embodiments, the destination is selected from the group consisting of an apartment, a house, a condominium, an, airport, a bus, a train, a ship, a cruise, a hospital, a nursing home, a senior citizen center, a rehabilitation center, a recreational center, a camping, a tailgating, a beach, a homeless shelter, a cook-out, and combinations thereof.

In one embodiment, the destination comprises a place where there is fuel shortage.

In another embodiment, the destination comprises a place where open flames are restricted or forbidden.

In some embodiments, the device is a clean energy device or a green device.

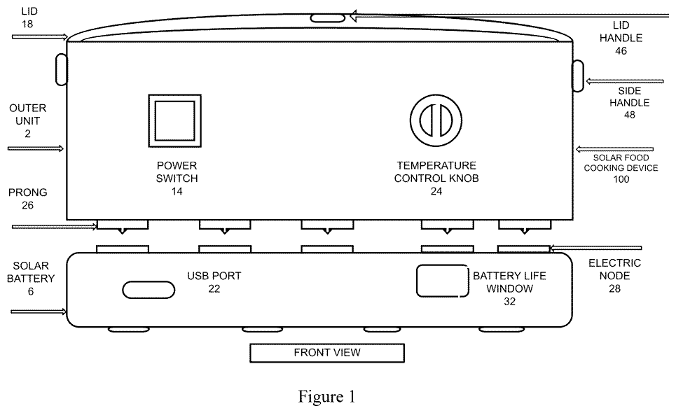

FIG. 1 illustrates the front view of the solar food cooking device in accord with the present invention. The solar food cooking device 100 of the preferred embodiment shows an outer unit 2; an inner unit 4; a solar battery 6; a solar panel 8; a heating element 10; an AC power input 12; a power switch 14; a solar panel cable 16; a temperature control knob 24; a plurality of prongs 26; a plurality of electric nodes 28; a solar panel output port 34; a solar panel input port 36; an AC/DC switch 42; and a lid 18. The outer unit 2 is at the top of the solar battery 6 and holds the inner unit 4. The inner unit 4 is inside the outer unit 2 and holds the food. The solar battery 6 is at the bottom of the device and holds the outer unit 2. The solar panel 8 is inside the outer unit 2 and on the back side of device. The solar panel 8 absorbs solar energy from sun and is attached to the solar battery 6 via a solar panel cable 16. The solar battery 6 stores solar energy from sun. The lid 18 is first placed on the top of the outer unit 2 and the solar food cooking device is then turned on. When the solar food cooking device is turned on, the solar energy from the solar battery 6 heats the heating element 10 to cook a food product.

In other embodiments of the invention, the solar food cooking device further can include a USB port 22 on the solar battery 6. The USB port 22 is used to charge an electronic device. The temperature control knob 24 indicates a temperature range.

In some embodiments of the invention, the outer unit 2 is made up of a material selected from the group consisting of stainless steel, ceramic, plastic, glass, metal, silicon, coils, wires and combinations thereof. The outer unit 2 has the inner unit 4 and the tray 20. The outer unit 2 has the heating element 10 housed within the walls of the outer unit 2. The heating element 10 has four or more prongs 26. The prongs 26 fit onto the electric nodes 28 of the solar battery 6. The solar battery 6 transfers the solar energy to the prongs 26 to heat the heating element 10 for cooking the food product. The outer unit 2 has handles on both the sides 48 (side handle). The outer unit 2 has the power switch 14. The power switch 14 is an on/off power switch.

In certain embodiments of the invention, the solar battery 6 is at the bottom of the device and holds the outer unit 2. The solar battery 6 has a plurality of electric nodes 28. The electric nodes 28 hold the prongs 26. The solar battery 6 is selected from the group consisting of a lead acid battery, a lithium-ion battery, a nickel-based battery, a flow battery, a LiFePO4 battery and combinations thereof. The nickel-based battery is a nickel cadmium battery. The solar battery 6 has a battery life indicator window 32 showing the percentage of charge in the solar battery 6 (battery life).

In some embodiments of the invention, the lid 18 is a detachable lid. The lid 18 is round in shape. The lid 18 has a handle on the top 46 (lid handle). The lid 18 is made up of a material selected from the group consisting glass, silicon, stainless steel, wood and combinations thereof.

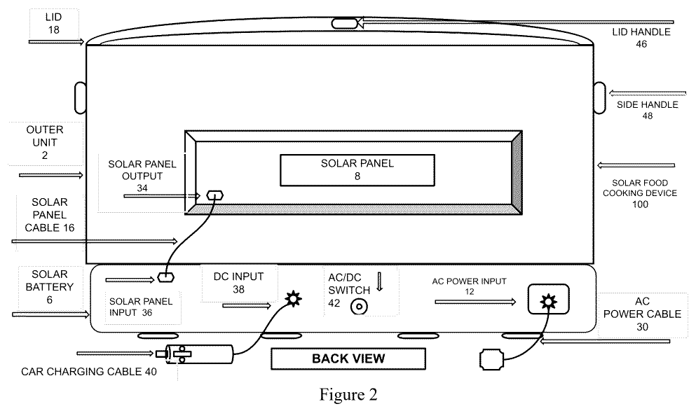

FIG. 2 illustrates the back view of the solar food cooking device in accord with the present invention. The solar food cooking device 100 of the preferred embodiment shows the solar panel 8 is connected to the solar battery 6 via a solar panel cable 16. The solar panel cable 16 transfers solar energy from solar panel 8 to solar battery 6. The solar panel 8 is removed from the back side of the outer unit once a battery is reached a full charge mode or can remain inside the outer unit while device is in cook mode. The solar food cooking device, further can include an AC power cable 30 for AC outlet charging. The AC power cable 30 transfers AC to solar battery when connected to alternate power source. An AC power input 12 has an AC power cable 30 to charge solar battery for AC outlet charging. The AC power cable 30 is detachable. The solar panel 8 is removed from the back side of the outer unit 2 once a battery is reached a full charge mode or can remain inside the outer unit 2 while device is in cook mode. The solar panel output port 34 connects solar panel cable 16 to allow solar energy to flow out of solar panel 8. The solar panel input port 36 connects solar panel cable 16 to allow solar energy to flow into solar battery 6. The solar food cooking device, further can include a DC input 38 for connecting car charging cable 40 to the solar battery to allow direct current to flow into solar battery 6. The solar food cooking device, further can include a car charging cable 40 for connecting the solar battery via DC input 38 to allow direct current to flow into solar battery 6. The AC/DC switch 42 allows solar food cooking device to cook the food product with either alternating current or direct current.

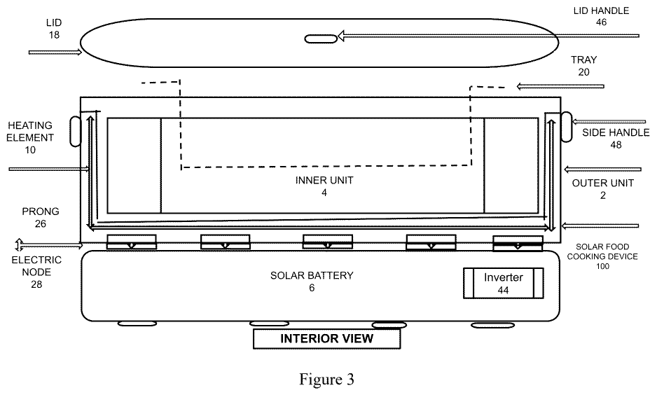

FIG. 3 illustrates the interior view of the solar food cooking device in accord with the present invention. The solar food cooking device 100 of the preferred embodiment shows that the outer unit 2 has the inner unit 4 and the tray 20. The outer unit 2 has the heating element 10 housed within the walls of the outer unit 2. The heating element 10 has four or more prongs 26. The prongs 26 fit onto the electric nodes 28 of the solar battery 6. The solar battery 6 transfers the solar energy to the prongs 26 to heat the heating element 10 for cooking the food product. The inner unit 4 holds the food product to be cooked. The inner unit 4 is made up of a material selected from the group consisting of stainless steel, ceramic, metal, silicon, non-stick material and combinations thereof. The inner unit 4 has an optional tray 20 to hold the food product to be cooked. The inner unit 4 can be removed from the device for easy cleaning. In some embodiments of the invention, the solar food cooking device further can include a tray 20. The tray 20 is placed inside the inner unit 4. The tray 20 is made up of a material selected from the group consisting of stainless steel, silicon, non-stick material and combinations thereof. The tray 20 holds the food product to be cooked. The solar food cooking device 100 of the preferred embodiment shows the detachable lid 18. The lid 18 is round in shape and has a handle on the top 46 (lid handle). The lid 18 is made up of a material selected from the group consisting of glass, silicon, stainless steel, wood and combinations thereof. The solar battery 6 is at the bottom of the device and holds the outer unit 2. The solar food cooking device further can include an inverter 44 for allowing solar battery to use direct current, solar energy, alternate current or combinations thereof.

### III. Methods of Cooking a Food Product in a Solar Food Cooking Device

The invention provides methods of cooking a food product in a solar food cooking device.

In other embodiments of the present invention, a method of cooking a food product in a solar food cooking device 100, can include exposing a solar panel 8 to a sun; absorbing a solar energy from sun into the solar panel 8; transferring the solar energy from the solar panel 8 to a solar battery 6 via a solar panel cable 16; storing the solar energy into the solar battery 6; placing a food product to be cooked on a tray 20 or on an inner unit 4; closing a lid 18 on the top of an outer unit 2; turning on the solar food cooking device 100; transferring solar energy from solar battery 6 to heat the food product; and heating the food product with solar energy at a temperature range of about 100° C. to about 175° C. to produce the cooked food product; wherein a time and the temperature of heating varies based on the type of the food product.

### IV. Methods of Using a Solar Food Cooking Device

The invention provides methods of using a solar food cooking device.

In further embodiments of the present invention, a method of using a solar food cooking device 100, can include charging a solar food cooking device 100 with a solar energy from sun; placing a food product to be cooked on a tray 20 or on an inner unit 4; closing a lid 18 on the top of an outer unit 2; turning on the solar food cooking device 100; heating the food product with solar energy at a temperature range of about 100° C. to about 175° C. to produce a cooked food product; and removing the cooked food product from the solar food cooking device 100, wherein the solar energy from sun is absorbed by the solar panel 8, wherein the solar energy is transferred from the solar panel 8 to a solar battery 6 via a solar panel cable 16 to store the solar energy, and wherein the stored solar energy from solar battery 6 is transferred to heat the food product.

### INDUSTRIAL APPLICATIONS

A solar food cooking device of the present invention offers several industrial applications including but not limited to, improved safety, efficiency, environmentally friendly, a green device and cost-effectiveness for the manufacture. The solar food cooking device that can be used where there is power outage. The solar food cooking device can be used where there is fuel shortage. The solar food cooking device can be used in emergency. The solar food cooking device has a dual power capacity. The solar food cooking device can be used at an apartment, a house, a condominium, an, airport, a bus, a train, a ship, a cruise, a hospital, a nursing home, a senior citizen center, a rehabilitation center, a recreational center, a camping, a tailgating, a beach, a homeless shelter, a cook-out, and combinations thereof. The solar food cooking device can cook multiple food products simultaneously.

While in the foregoing specification this invention has been described in relation to certain embodiments thereof, and many details have been put forth for the purpose of illustration, it will be apparent to those skilled in the art that the invention includes additional embodiments and that certain of the details described herein can be varied considerably without departing from the basic principles of the invention. Although we have described the preferred embodiments for implementing our invention, it will be understood by those skilled in the art to which this disclosure is directed that modifications and additions may be made to our invention without departing from its scope.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. A solar food cooking device, comprising:
an outer unit;
an inner unit;
a solar battery;
a solar panel;
a heating element;
an AC power input;
a power switch;
a solar panel cable;
a temperature control knob;
a plurality of prongs;
a plurality of electric nodes;
a solar panel output port;
a solar panel input port;
an AC/DC switch; and
a lid;
wherein the outer unit is at the top of the solar battery and holds the inner unit,
wherein the inner unit is inside the outer unit and holds the food,
wherein the solar battery is at the bottom of the device and holds the outer unit,
wherein the solar panel is inside the outer unit and on the back side of device,
wherein the solar panel absorbs solar energy from sun and is attached to the solar battery via the solar panel cable,
wherein the solar battery stores solar energy from sun,
wherein the lid is first placed on the top of the outer unit and the solar food cooking device is then turned on; and
wherein when the solar food cooking device is turned on, the solar energy from the solar battery heats the heating element to cook a food product.

2. The solar food cooking device of claim 1, further comprising a tray.

3. The solar food cooking device of claim 1, further comprising a USB port on the solar battery.

4. The solar food cooking device of claim 1, wherein the outer unit is made up of a material selected from the group consisting of stainless steel, ceramic, plastic, glass, metal, silicon, coils, wires and combinations thereof.

5. The solar food cooking device of claim 1, wherein the inner unit is made up of a material selected from the group consisting of stainless steel, ceramic, metal, silicon, non-stick material and combinations thereof.

6. The solar food cooking device of claim 1, wherein the solar battery is selected from the group consisting of a lead acid battery, a lithium-ion battery, a nickel-based battery, a flow battery a LiFePO4 battery and combinations thereof.

7. The solar food cooking device of claim 6, wherein the nickel-based battery is a nickel cadmium battery.

8. The solar food cooking device of claim 1, further comprising an AC power cable for AC outlet charging.

9. The solar food cooking device of claim 1, further comprising a battery life indicator window showing the percentage of charge in the solar battery.

10. The solar food cooking device of claim 1, further comprising a DC input for connecting car charging cable to the solar battery to allow direct current to flow into solar battery.

11. The solar food cooking device of claim 1, further comprising a car charging cable for connecting the solar battery via DC input to allow direct current to flow into solar battery.

12. The solar food cooking device of claim 1, further comprising an inverter for allowing solar battery to use direct current, solar energy, alternate current or combinations thereof.

13. The solar food cooking device of claim 1, wherein the device is a solar food cooker.

14. The solar food cooking device of claim 1, wherein the food product is selected from the group consisting rice, meat product, beans, vegetable, grain, seafood, fruit, and combinations thereof.

15. The solar food cooking device of claim 1, wherein the device can be used at a destination.

16. The solar food cooking device of claim 15, wherein the destination is selected from the group consisting of an apartment, a house, a condominium, an, airport, a bus, a train, a ship, a cruise, a hospital, a nursing home, a senior citizen center, a rehabilitation center, a recreational center, a camping, a tailgating, a beach, a homeless shelter, a cook-out, and combinations thereof.

17. The solar food cooking device of claim 15, wherein the destination comprises a place where there is fuel shortage, a place where open flames are restricted or forbidden or combinations thereof.

18. The solar food cooking device of claim 1, wherein the device is a clean energy device or a green device.

19. A method of cooking a food product in a solar food cooking device, comprising:
exposing a solar panel to a sun;
absorbing a solar energy from sun into the solar panel;
transferring the solar energy from the solar panel to a solar battery via a solar panel cable;
storing the solar energy into the solar battery;
placing a food product to be cooked on a tray or on an inner unit;
closing a lid on the top of an outer unit;
turning on the solar food cooking device;
transferring solar energy from solar battery to heat the food product; and
heating the food product with solar energy at a temperature range of about 100° C. to about 175° C. to produce the cooked food product;
wherein a time and the temperature of heating varies based on the type of the food product.

20. A method of using a solar food cooking device, comprising:
charging a solar food cooking device with a solar energy from sun;
placing a food product to be cooked on a tray or on an inner unit;
closing a lid on the top of an outer unit;
turning on the solar food cooking device;
heating the food product with solar energy at a temperature range of about 100° C. to about 175° C. to produce a cooked food product; and
removing the cooked food product from the solar food cooking device,
wherein the solar energy from sun is absorbed by the solar panel,
wherein the solar energy is transferred from the solar panel to a solar battery via a solar panel cable 16 to store the solar energy, and
wherein the stored solar energy from solar battery is transferred to heat the food product.
